(19) United States
(12) Patent Application Publication
(10) Pub. No.: US 2010/0055571 A1
(43) Pub. Date: Mar. 4, 2010

(54) CURRENT COLLECTOR FOR THE ANODE OF A PRIMARY LITHIUM ELECTROCHEMICAL GENERATOR

(75) Inventors: Laure LE GUENNE, Bruges (FR); Patrick Bernard, Bordeaux (FR); Olivier Huchet, Latresne (FR)

Correspondence Address: SUGHRUE MION, PLLC, 2100 PENNSYLVANIA AVENUE, N.W., SUITE 800, WASHINGTON, DC, 20037, US

(73) Assignee: SAFT GROUPE SA, Bagnolet (FR)

(21) Appl. No.: 12/505,110

(22) Filed: Jul. 17, 2009

(30) Foreign Application Priority Data
Aug. 29, 2008 (FR) 08 04 756

(51) Int. Cl. H01M 4/58

(52) U.S. Cl. 429/231.95

(57) ABSTRACT

An electrode comprising a metallic lithium strip (1) and on at least one of its surfaces, at least one open-worked current collector strip (2), the ratio of the widths of the current collector strip(s) to the width of the metallic lithium strip ranging from 0.3 to 0.8, the proportion of openwork of each current collector strip ranging from 30 to 95%, the metallic lithium strip and the at least one current collector strip(s) being of substantially identical lengths.

This electrode is advantageously used as the anode of a primary lithium electrochemical generator for example of the liquid cathode type such as Li/SO₂, of the Li/MnO₂ type or of the Li/CFₓ type with x comprised between 0.5 and 1 in order to reduce the quantity of non-discharged residual lithium.

### FIELD OF THE INVENTION

The invention relates to the technical field of primary lithium electrochemical generators and more particularly the current collectors used in the manufacture of the anodes of such generators.

### PRIOR ART

The technical field of the invention is that of primary lithium electrochemical generators. The term “primary” denotes a non-rechargeable electrochemical generator, also denoted by the term “cell”, in contrast to the term “secondary” which denotes a rechargeable electrochemical generator also denoted by the term “accumulator”.

The family of primary lithium generators also comprises primary liquid cathode generators and primary generators with organic electrolyte.

Primary generators with liquid cathodes of the Li/SO₂, Li/SOCl₂ and Li/SO₂Cl₂ types are known. The anode (or negative electrode) is made of metallic lithium. The cathode (or positive electrode) is a porous mass of carbon with a large specific surface area impregnated with a liquid mixture comprising an organic solvent such as acetonitrile, a salt such as lithium bromide LiBr and an oxidizing compound which can be chosen from sulphurous anhydride SO₂, thionyl chloride SOCl₂ and sulphuryl chloride SO₂Cl₂. During the discharge of such a generator, the oxidation of the metallic lithium to lithium ions takes place at the anode according to the following reaction:

2Li→2Li⁺+2e⁻

At the cathode, the reduction of the oxidizing compound takes place. In the case where the oxidizing agent is sulphurous anhydride SO₂, the reduction reaction is the following:

2SO₂+2e⁻→S₂O₄²⁻

Primary generators with organic electrolyte of the Li/MnO₂ and Li/CFₓ type are known. The anode is made of metallic lithium. The cathode is a material capable of intercalating lithium into its structure, such as for example MnO₂ or (CF)ₓ. During discharge, the oxidation of the metallic lithium to lithium ions takes place at the anode, as for a primary liquid cathode generator. At the cathode during discharge, the intercalation of lithium into CF, produces insoluble lithium fluoride and graphite, an electronic conductor. In the case where the intercalation material is MnO₂, the compound LiMnO₂ is formed. The organic solvents used can be propylene carbonate or dimethoxyethane. The salt used can be chosen from lithium perchlorate LiClO₄, lithium hexafluoroarsenate LiAsF₆, or lithium hexafluorophosphate LiPF₆.

Such generators are generally constructed with a spirally wound assembly of the anode so as to obtain a high power. The anode is generally constituted by a laminated current collector strip on a metallic lithium strip. The current collector can be a copper ribbon. The current terminal is connected to the lithium strip.

The metallic lithium anode of the generators described above lacks efficiency during discharge. In fact, at the end of the discharge of an Li/SO₂, Li/MnO₂ or Li/CFₓ generator, non-discharged lithium zones appear on the anode. The quantity of residual lithium in the discharged state is significant since it can represent up to 25% with respect to the quantity of lithium for a generator in the charged state. It is possible to envisage increasing the width of the current collector in order to attempt to solve the problem. However, a simple increase in the width of the collector is not sufficient to solve the problem as the current collector then masks too large a part of the electrochemically active area of the lithium.

A primary lithium electrochemical generator is therefore sought, having a quantity of residual lithium, i.e. non-discharged, smaller than those of the prior art. The reduction in the quantity of residual lithium at the end of discharge will lead to an increase in the capacity of the generator.

The document U.S. Pat. No. 4,482,615 describes a primary electrochemical generator of Li/SO₂ type, in which the anode comprises a solid metallic copper strip serving as a current collector, which is laminated onto a lithium strip. The ratio of the surface area of the copper strip to the surface area of the metallic lithium strip is from 0.02 to 0.25. The copper strip can be replaced by a copper wire. It is said that this assembly aims to provide a lithium electrochemical generator having increased safety in the case of forced discharge.

### SUMMARY OF THE INVENTION

A subject of the invention is an electrode comprising a metallic lithium strip and on at least one of its surfaces, at least one open-worked current collector strip, the ratio of the widths of the current collector strip(s) to the width of the metallic lithium strip ranging from 0.2 to 1, the proportion of openwork of each current collector strip ranging from 30 to 95%, the metallic lithium strip and the at least one current collector strip(s) being of substantially identical lengths.

According to an embodiment, the ratio of the widths of the current collector strip(s) to the width of the metallic lithium strip ranges from 0.3 to 0.8, preferably from 0.4 to 0.7.

According to an embodiment, the proportion of openwork ranges from 50 to 90%, preferably from 70 to 90%, preferably also from 60 to 85%.

According to an embodiment, said at least one current collector strip is chosen from the group comprising a perforated metal, an expanded metal, a grid, a metallic fabric or a metallic foam.

According to an embodiment, at least one of the surfaces of the metallic lithium strip comprises two current collector strips.

According to an embodiment, the current collector strip is constituted by a material chosen from the group comprising copper, stainless steel, aluminum and nickel. Preferably, one of the current collector strips is made of copper and the other current collector strip is made of stainless steel.

A subject of the invention is also a primary electrochemical generator with a non-aqueous electrolyte comprising at least one electrode described previously.

According to an embodiment, the primary electrochemical generator with a non-aqueous electrolyte is of liquid cathode type, such as Li/SO₂.

According to an embodiment, the primary electrochemical generator with a non-aqueous electrolyte is of the Li/MnO₂ type or of the Li/CFₓ type where x is comprised between 0.5 and 1.

### BRIEF DESCRIPTION OF THE FIGURES

FIG. 1 represents a plan view of the metallic lithium strip (1) on which the open-worked current collector strip (2) is arranged.

FIG. 2 represents a plan view of the metallic lithium strip (1) on which two open-worked current collector strips (2-1) (2-2) are arranged.

### DETAILED DISCLOSURE OF THE EMBODIMENTS

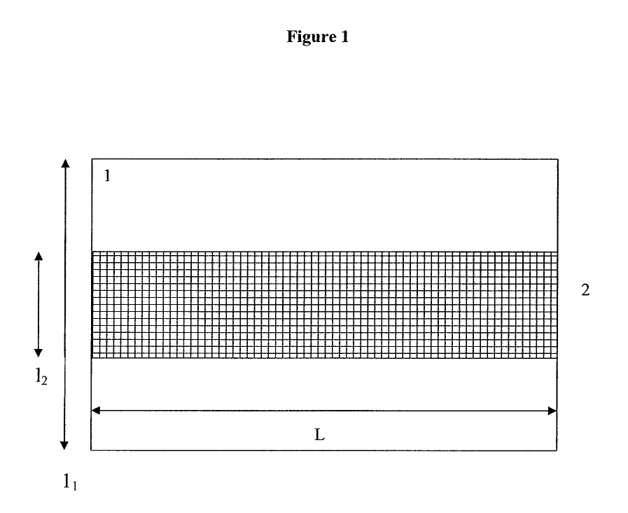

A metallic lithium strip (1) is used as the anode of the generator. At least one current collector strip (2) is fixed to at least one surface of the metallic lithium strip. FIG. 1 represents a plan view of the metallic lithium strip (1) on which an open-worked current collector strip (2) is arranged. The current collector is characterized by the fact that it is open-worked, i.e. that its surface area comprises cut-out parts. The proportion of openwork is defined as the ratio between the surface area of the strip void of material and the total surface area of the strip obtained by multiplying the width of the strip by its length. The proportion of openwork of the current collector is comprised between 30% and 95%, preferably comprised between 50% and 90%, preferably also comprised between 70% and 90%.

The same surface of the metallic lithium strip can comprise several current collector strips.

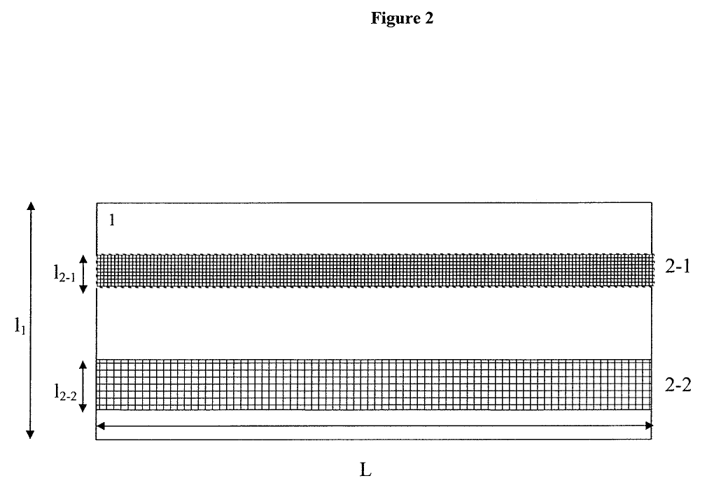

According to an embodiment, two current collector strips are arranged on the same surface of the metallic lithium strip. This embodiment is illustrated in FIG. 2. One of the surfaces of the metallic lithium strip (1) comprises two current collector strips (2-1) and (2-2). The two current collector strips can have identical or different amounts of openwork. They can be made of materials of an identical or different nature. They can be of identical or different widths. According to a preferred embodiment, one of the current collector strips is made of copper and the other is made of stainless steel. The use of copper is advantageous in the case where the generator is subjected to excessive discharge. The use of stainless steel has an advantage in terms of cost.

According to an embodiment, the metallic lithium strip comprises one or more current collector strips on both its surfaces.

The current collector strip can be for example fixed to the metallic lithium strip by a lamination process. The metallic lithium strip typically has a thickness preferably ranging from 80 microns to 400 microns.

The current collector strip can be a perforated metal, an expanded metal, a grid, a metallic fabric or a metallic foam. Its thickness is preferably comprised between 0.020 mm and 0.5 mm, preferably comprised between 0.050 mm and 0.3 mm, preferably also between 0.1 and 0.2 mm. The material serving as a current collector is preferably chosen from the group comprising copper, stainless steel, aluminum and nickel. Preferably, this material is copper as it has a high electric conductivity.

The small thickness of the lithium strip and of the current collector strip confers a flexibility on the anode. This makes it possible to achieve a spirally wound assembly of the anode.

The metallic lithium strip and the current collector strip are of substantially identical lengths. Preferably, they are of identical lengths in order to use to the maximum the quantity of lithium available and therefore reduce the quantity of residual lithium.

The ratio between the width of the current collector strip l₂ and the width of the metallic lithium strip l₁ is comprised between 0.2 and 1. In the case where one of the surfaces of the metallic lithium strip comprises at least two current collector strips, this is the ratio between the sum of the widths of the current collector strips and the width of the lithium strip which is comprised between 0.2 and 1. FIG. 2 represents a first current collector strip (2-1) of width l₂₋₁ and a second current collector strip (2-2) of width l₂₋₂. The ratio (l₂₋₁+l₂₋₂)/l₁ is comprised between 0.2 and 1.

The negative current output terminal can be connected either to the current collector strip, or to the metallic lithium strip, or to both.

The electrode according to the invention can be used as an anode (negative electrode) of a primary generator with a non-aqueous electrolyte of the Li/SO₂ type. For this type of generator, the current collector positive material is based on an electronic conductive material of low porosity. It can be made of carbon or carbon aerogel. The positive active liquid SO₂ is located in the pores of the material current collector.

The electrode according to the invention can be used as the anode of a primary generator of Li/MnO₂ type or also of Li/CFₓ type where x is comprised between 0.5 and 1.

Other characteristics and advantages of the present invention will become apparent on reading the following description of an embodiment.

### EXAMPLES

The reference negative electrode N1, is prepared from a metallic lithium strip and a solid current collector made of copper for which the ratio between the width of the collector l₂ and the width of the lithium strip l₁ is equal to 0.15. The terminal is connected to the metallic lithium strip.

The negative electrode N2 is prepared from a metallic lithium strip and a current collector of expanded type made of copper with 85% openwork, for which the ratio between the width of the collector and the width of the lithium strip is equal to 0.7. The terminal is connected to the current collector.

The negative electrode N3, not forming part of the invention, is prepared from a metallic lithium strip and a current collector of expanded type made of copper with 85% openwork, for which the ratio between the width of the collector and the width of the lithium strip is equal to 0.15. The terminal is connected to the current collector.

The negative electrode N4 is prepared from a metallic lithium strip and a current collector of perforated type made of copper, with 50% openwork, for which the ratio between the width of the collector and the width of the lithium strip is equal to 0.4. The terminal is connected to the current collector.

The negative electrode N5, not forming part of the invention, is prepared from a metallic lithium strip and a current collector of perforated type made of copper, with 10% openwork, for which the ratio between the width of the collector and the width of the lithium strip is equal to 0.7. The terminal is connected to the current collector.

The negative electrode N6 is prepared from a metallic lithium strip and two current collectors of expanded type made of copper, with 50% openwork, for which the ratio between the sum of the widths of the collector and the width of the lithium strip is equal to 0.7. The terminal is connected to the two current collectors.

The negative electrode N7 is prepared from a metallic lithium strip and a solid current collector made of copper, for which the ratio between the width of the collector and the width of the lithium strip is equal to 0.7. The terminal is connected to the current collector.

TABLE 1

| Negative electrode | N1 | N2 | N3 | N4 | N5 | N6 | N7 |
|---|---|---|---|---|---|---|---|
| Width of the collector/ | 0.15 | 0.7 | 0.15 | 0.4 | 0.7 | 0.7 | 0.7 |
| Width of the lithium strip | | | | | | | |
| (l₂/l₁) | | | | | | | |
| Proportion of openwork in | 0 | 85 | 85 | 50 | 10 | 50 | 0 |
| the collector (%) | | | | | | | |
| Type of collector | solid | expanded | expanded | perforated | perforated | expanded | solid |
| Number of collectors | 1 | 1 | 1 | 1 | 1 | 2 | 1 |

The reference positive electrode P1 has the following weight composition (expressed in % with respect to the paste):

Carbon black 90%

PTFE 10%

The porosity of the positive electrode is 80%. The current collector is an aluminum grid.

A primary electrochemical generator Li/SO₂ of format ⅔ C the nominal capacity of which is 2.35 Ah at 2V is constituted by a positive electrode and a negative electrode described above. The electrodes are separated by a polypropylene-polyethylene separator in order to form the electrochemical bundle. The bundle spirally wound in this way is inserted into a metallic cup and impregnated with a non-aqueous electrolyte constituted by an LiBr salt in a mixture of acetonitrile and SO₂ in order to constitute the generators.

TABLE 2

| Series | Negative electrode | Positive electrode |
|---|---|---|
| A | N1 | P1 |
| B | N2 | P1 |
| C | N3 | P1 |
| D | N4 | P1 |
| E | N5 | P1 |
| F | N6 | P1 |
| G | N7 | P1 |

### Electrochemical Performances:

The generators are subjected to a discharge at 650 mA (C/3.5) at 20° C. up to 0V. The capacity is measured at 2V.

TABLE 3

| Series | A | B | C | D | E | F | G |
|---|---|---|---|---|---|---|---|
| Capacity at 20° C. | 2.35 | 2.7 | 2.3 | 2.5 | 2.2 | 2.65 | 2.15 |
| (Ah) | | | | | | | |

It is understood from these results that the use of an open-worked collector in generators of series B, D and F, makes it possible to significantly improve the capacity of the generators with a discharge voltage at 2V by comparison with generators of series A and G which include a solid collector.

When the collector does not have a sufficient width in relation to the width of the lithium strip (generators of series C, outside the field of the invention), the quantity of residual lithium at the end of discharge remains significant and this solution does not allow any gain in capacity.

Furthermore, when the proportion of openwork in the collector is too small, i.e. less than 30% (generators of series E, outside the field of the invention), the discharged capacity is low because the collector masks too large a part of the electrochemically active area of the lithium. For the same reason, the use of a solid current collector, with a width greater than the width of the reference collector N1 leads to a low capacity (generators of series G, outside the field of the invention).

1. Electrode comprising a metallic lithium strip (1) and on at least one of its surfaces, at least one open-worked current collector strip (2), the ratio of the widths of the current collector strip(s) to the width of the metallic lithium strip ranging from 0.3 to 0.8, the proportion of openwork of each current collector strip ranging from 30 to 95%, the metallic lithium strip and the at least one current collector strip(s) being of substantially identical lengths.

2. Electrode according to claim 1, in which the ratio of the widths of the current collector strip(s) to the width of the metallic lithium strip ranges from 0.4 to 0.7.

3. Electrode according to claim 1, in which the proportion of openwork ranges from 50 to 90%, preferably from 70 to 90%, preferably also from 60 to 85%.

4. Electrode according to claim 1, in which said at least one current collector strip is chosen from the group comprising a perforated metal, an expanded metal, a grid, a metallic fabric or a metallic foam.

5. Electrode according to claim 1, in which at least one of the surfaces of the metallic lithium strip comprises two current collector strips.

6. Electrode according to claim 1, in which the current collector strip is constituted by a material chosen from the group comprising copper, stainless steel, aluminum and nickel.

7. Electrode according to claims 5 and 6, in which one of the current collector strips is made of copper and the other current collector strip is made of stainless steel.

8. Primary electrochemical generator with non-aqueous electrolyte comprising at least one electrode according to claim 1.

9. Primary electrochemical generator with non-aqueous electrolyte according to claim 8, of the liquid cathode type, such as Li/SO₂.

10. Primary electrochemical generator with non-aqueous electrolyte according to claim 8, of the Li/MnO₂ type or of the Li/CFₓ type where x is comprised between 0.5 and 1.
